(19) United States
(12) Patent Application Publication
(10) Pub. No.: US 2024/0168483 A1
(43) Pub. Date: May 23, 2024

(54) MOBILE ROBOT AND METHOD OF CONTROLLING THE SAME

(71) Applicant: SAMSUNG ELECTRONICS CO., LTD., Suwon-si (KR)

(72) Inventors: Minwoo RYU, Suwon-si (KR); Taegyu KIM, Suwon-si (KR); Jinwook YOON, Suwon-si (KR); Euihyun JUNG, Suwon-si (KR); Jihoon HA, Suwon-si (KR)

(73) Assignee: SAMSUNG ELECTRONICS CO., LTD., Suwon-si (KR)

(21) Appl. No.: 18/237,188

(22) Filed: Aug. 23, 2023

Related U.S. Application Data
(63) Continuation of application No. PCT/KR2023/010925, filed on Jul. 27, 2023.

(30) Foreign Application Priority Data
Nov. 18, 2022 (KR) 10-2022-0155766

(51) Int. Cl. G05D 1/02; H02J 7/00

(52) U.S. Cl. CPC G05D 1/0225; G05D 1/0274; H02J 7/0042; G05D 2201/0208

(57) ABSTRACT

A mobile robot, and a method of controlling the mobile robot, the mobile robot including a communication interface configured to communicate with a beacon; a metal sensor configured to detect a metal guide connected to a charging station; and a controller configured to control the communication interface to communicate with the beacon to obtain position information of the mobile robot, obtain a distance between the mobile robot and the charging station based on the obtained position information of the mobile robot and indoor map information, and based on the obtained distance being less than a first reference distance, operate the metal sensor to detect the metal guide.

### BACKGROUND

### 1. Field

The disclosure relates to a mobile robot capable of docking onto a charging station, and a method of controlling the same.

### 2. Description of the Related Art

Robots have been developed for industrial purpose, taking part of factory automation. In recent years, the application of robots has been further expanded such that medical robots, space robots, etc., have been developed, and household robots usable at home are also being produced. Among the robots, robots capable of autonomously travelling are referred to as mobile robots. A representative mobile robot used in outdoor environments in households is a lawn mower robot.

A lawn mower is a device for trimming grass planted in a home yard or playground, and includes a walk-behind type lawn mower or hand type lawn mower requiring manual dragging or pushing by a user to mow the lawn, and a lawn mower capable of autonomous driving.

Compared to mobile robots autonomously travelling indoors, lawnmowers autonomously travelling outdoors have a difficulty in docking onto a charging station due to obstacles, such as cut grass or soil.

To this end, the lawn mower robot may be equipped with a sensor for docking onto a charging station and performing docking smoothly.

### SUMMARY

Aspects of embodiments of the disclosure will be set forth in part in the description which follows and, in part, will be apparent from the description, or may be learned by practice of the presented embodiments.

According to an embodiment of the disclosure, a mobile robot includes a communication interface configured to communicate with a beacon; a metal sensor configured to detect a metal guide connected to a charging station; and a controller configured to control the communication interface to communicate with the beacon to obtain position information of the mobile robot, obtain a distance between the mobile robot and the charging station based on the obtained position information of the mobile robot and indoor map information, and based on the obtained distance being less than a first reference distance, operate the metal sensor to detect the metal guide.

According to an embodiment of the disclosure, the mobile robot further includes a driver configured to drive the mobile robot, and the controller may be configured to control the driver such that the mobile robot travels along the metal guide and docks onto the charging station.

According to an embodiment of the disclosure, the controller may be configured to, based on detecting absence of the metal guide for a second reference distance after the mobile robot starts traveling along the metal guide, control the metal sensor to stop detecting the metal guide, control the mobile robot to change a position, and after the position of the mobile robot is changed, control the metal sensor to rediscover the metal guide.

According to an embodiment of the disclosure, the controller may be configured to, based on an increase in the distance between the mobile robot and the charging station while traveling along the metal guide, control the metal sensor to stop detecting the metal guide, control the mobile robot to change a position of the mobile robot, and after the position of the mobile robot is changed, control the metal sensor rediscover the metal guide.

According to an embodiment of the disclosure, the metal guide may extend outward from the charging station along a surface on which the mobile robot travels.

According to an embodiment of the disclosure, the metal guide connected to the charging station may include a plurality of metal guides, and the metal sensor of the mobile robot may include a plurality of metal sensors corresponding to the plurality of the metal guides.

According to an embodiment of the disclosure, the controller may be configured to determine which metal sensor among the plurality of the metal sensors detects a metal guide among the plurality of the metal guides.

According to an embodiment of the disclosure, the controller may be configured to, based on a position of the determined metal sensor among the plurality of the metal sensors, control a movement angle of the mobile robot for docking onto the charging station.

According to an embodiment of the disclosure, the controller may be configured to, based on completion of the docking onto the charging station, control a docking completion and charging start message to be displayed on an output device.

According to an embodiment of the disclosure, the controller may be configured to, based on completion of the docking onto the charging station, control the communication interface to transmit a docking completion and charging start message to a user terminal.

According to an embodiment of the disclosure, a method of controlling a mobile robot including a communication interface configured to communicate with a beacon, and a metal sensor configured to detect a metal guide connected to a charging station, includes communicating with the beacon to obtain position information of the mobile robot; obtaining a distance between the mobile robot and the charging station based on the obtained position information of the mobile robot and indoor map information; and based on the obtained distance being less than to a first reference distance, operating the metal sensor to detect the metal guide.

According to an embodiment of the disclosure, the method may further include controlling a driver such that the mobile robot travels along the metal guide and docks onto the charging station.

According to an embodiment of the disclosure, the method may further include, based on detecting absence of the metal guide for a second reference distance after the mobile robot starts traveling along the metal guide, stopping detecting the metal guide; changing a position of the mobile robot; and after the position of the mobile robot is changed, rediscovering the metal guide.

According to an embodiment of the disclosure, the method may further include, based on an increase in the distance between the mobile robot and the charging station while traveling along the metal guide, stopping detecting the metal guide; changing a position of the mobile robot; and after the position of the mobile robot is changed, rediscovering the metal guide.

According to an embodiment of the disclosure, the metal guide may extend outward from the charging station along a surface on which the mobile robot travels.

According to an embodiment of the disclosure, the metal guide connected to the charging station may include a plurality of metal guides, and the metal sensor of the mobile robot may include a plurality of metal sensors corresponding to the plurality of the metal guides.

According to an embodiment of the disclosure, the method may further include determining which metal sensor among the plurality of the metal sensors detects a metal guide among the plurality of the metal guides.

According to an embodiment of the disclosure, the method may further include, based on a position of the determined metal sensor among the plurality of the metal sensors, controlling a movement angle of the mobile robot for docking onto the charging station.

According to an embodiment of the disclosure, the method may further include, based on completion of the docking onto the charging station, displaying a docking completion and charging start message on an output device.

According to an embodiment of the disclosure, the method may further include, based on completion of the docking onto the charging station, controlling the communication interface to transmit a docking completion and charging start message to a user terminal.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 is a perspective view illustrating a mobile robot according to an embodiment of the disclosure;

FIG. 2 is an elevation view of a mobile robot according to an embodiment of the disclosure, which is viewed from the front side;

FIG. 3 is an elevation view of a mobile robot according to an embodiment of the disclosure, which is viewed from the right side;

FIG. 4 is an elevation view of a mobile robot according to an embodiment of the disclosure, which is viewed from the lower side;

FIG. 5 is a control block diagram illustrating a mobile robot according to an embodiment of the disclosure;

FIG. 6 is a schematic view illustrating a mobile robot and a charging station for the mobile robot according to an embodiment of the disclosure;

FIG. 7 is a view illustrating a case in which a mobile robot moves to an area within a reference distance according to an embodiment of the disclosure;

FIG. 8A is a view illustrating a metal guide and a metal sensor of a mobile robot according to an embodiment of the disclosure;

FIG. 8B is a view illustrating a metal guide and a metal sensor of a mobile robot according to an embodiment of the disclosure;

FIG. 9A is view illustrating a case in which a plurality of metal sensors of a mobile robot are provided according to an embodiment of the disclosure;

FIG. 9B is view illustrating a case in which a plurality of metal guides of a mobile robot are provided according to an embodiment of the disclosure;

FIG. 10A is view illustrating a case in which a plurality of metal sensors of a mobile robot are provided according to an embodiment of the disclosure;

FIG. 10B is view illustrating a case in which a plurality of metal guides of a mobile robot are provided according to an embodiment of the disclosure;

FIG. 11 is a view illustrating a case in which a metal guide is detected only by some metal sensors of a mobile robot according to an embodiment of the disclosure;

FIG. 12 is a view illustrating a case in which a metal guide protrudes outward from a charging station to allow obstacle avoidance according to an embodiment of the disclosure;

FIG. 13 is a view illustrating a case in which a mobile robot transmits a message to a user terminal according to an embodiment of the disclosure;

FIG. 14 is a control flowchart of a mobile robot according to an embodiment of the disclosure; and

FIG. 15 is a control flowchart of mobile robot according to an embodiment of the disclosure.

### DETAILED DESCRIPTION

The embodiments described in the present specification and the configurations shown in the drawings are only examples of embodiments of the present disclosure, and various modifications may be made at the time of filing of the present disclosure to replace the embodiments and drawings of the present specification.

In addition, the terms used herein are for the purpose of describing the embodiments and are not intended to restrict and/or to limit the present disclosure. For example, the singular expressions herein may include plural expressions, unless the context clearly dictates otherwise.

The terms “comprises” and “has” are intended to display that there are features, numbers, steps, operations, elements, parts, or combinations thereof described in the specification, and do not exclude the presence or addition of one or more other features, numbers, steps, operations, elements, parts, or combinations thereof.

The terms, such as “˜ part”, “˜device”, “˜block”, “˜member”, “˜ module”, and the like may refer to a unit for processing at least one function or act. For example, the terms may refer to at least process processed by at least one hardware, such as field-programmable gate array (FPGA)/application specific integrated circuit (ASIC), software stored in memories, or processors.

It will be understood that, although the terms first, second, etc., may be used herein to describe various components, these components should not be limited by these terms. These terms are only used to differentiate one component from another.

Reference numerals used for method steps are just used for convenience of explanation, but not to limit an order of the steps. Thus, unless the context clearly dictates otherwise, the written order may be practiced otherwise.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

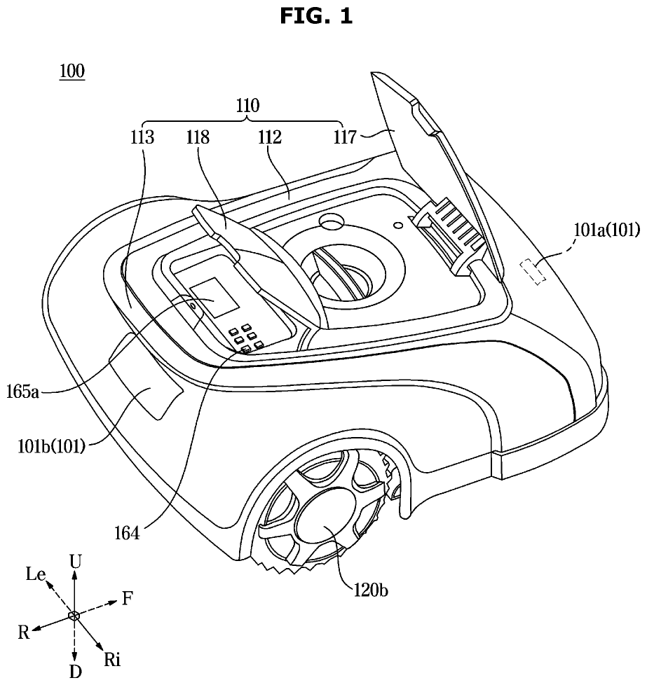

In addition, in this specification, the terms “front,” “rear,” “upper,” “lower,” right,” and “left” are defined based on the directions illustrate in FIG. 1, but the terms may not restrict the shape and position of the respective components.

Embodiments of the disclosure may provide a mobile robot capable of docking onto a charging station by detecting a metal guide, and a method of controlling the same.

The technical aspects of the present disclosure are not limited to the above, and other aspects may become apparent to those of ordinary skill in the art based on the following description.

Hereinafter, with reference to the accompanying drawings, a mobile robot and a control method thereof according to one aspect will be described in detail according to the following embodiments. In the drawings, the same reference numerals denote the same components, and redundant description thereof will be omitted.

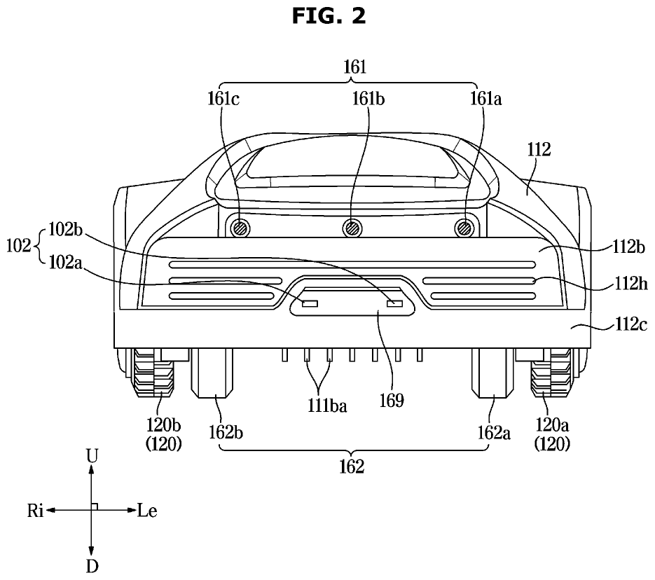

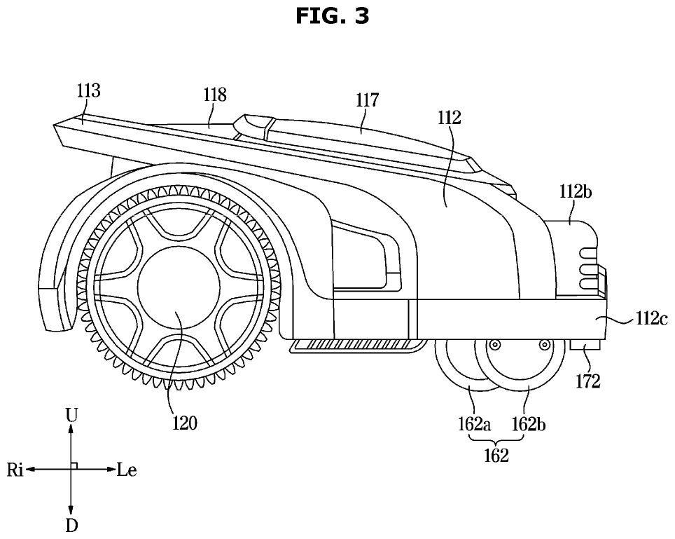

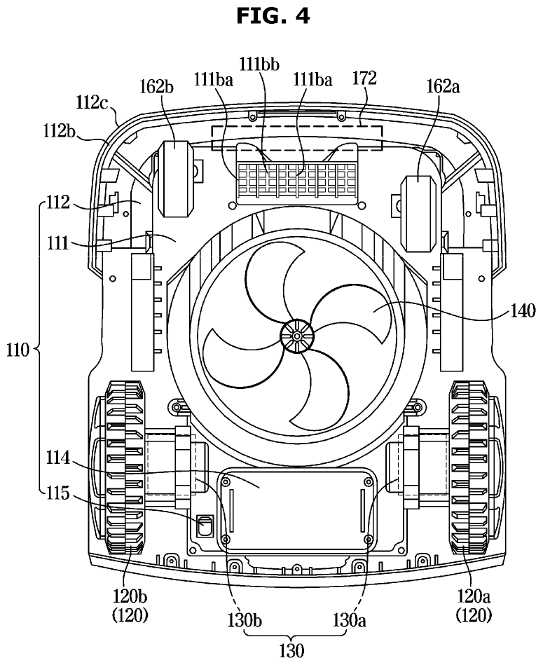

FIG. 1 is a perspective view illustrating a mobile robot according to an embodiment, FIG. 2 is an elevation view of a mobile robot according to an embodiment, which is viewed from the front side, FIG. 3 is an elevation view of a mobile robot according to an embodiment, which is viewed from the right side, and FIG. 4 is an elevation view of a mobile robot according to an embodiment, which is viewed from the lower side.

Referring FIGS. 1 to 4, a mobile robot 100 includes a body 110 forming the external appearance thereof. The body 110 forms an inner space.

The body 110 includes a first opening/closing portion 117 that opens and closes a portion in which a blade 140 is disposed. The first opening/closing portion 117 is hinged to a case 112, and provided to enable opening and closing operations. The first opening/closing portion 117 is disposed on the upper side of the case 112.

The body 110 includes a second opening/closing portion 118 that opens and closes a portion in which a display module 165a and an input device 164 are disposed. The second opening/closing portion 118 is hinged to the case 112, and provided to enable opening and closing operations. The second opening/closing portion 118 is disposed on the upper side of the case 112. The second opening/closing portion 118 is disposed at the rear of the first opening/closing portion 117. The second opening/closing portion 118 is formed in a plate shape and covers the display module 165a and the input device 164 in a closed state.

The body 110 includes a handle 113. The handle 113 may be disposed on the rear side of the case 112. The body 110 includes a battery loading portion 114 for inserting and withdrawing a battery Bt. The battery loading portion 114 may be disposed on a lower side of a frame 111. The battery loading portion 114 may be disposed on a rear side of a frame 111.

The body 110 includes a power switch 115 for turning on/off the power of the mobile robot 100. The power switch 115 may be disposed on the lower side of the frame 111.

The body 110 includes a bumper 112b disposed on a front side of the body 110. The bumper 112b performs a function of absorbing impact upon contact with an external obstacle. The bumper 112b is provided at a front side thereof with a bumper groove 112h that is recessed rearward and elongated in the left and right direction. A plurality of the bumper grooves 112h may be spaced apart from each other in the vertical direction. A lower end of a protruding rib 111ba is disposed at a position lower than that of a lower end of an auxiliary rib 111bb.

The bumper 112b has a front surface and left and right side surfaces connected to the front surface. The front surface and the side surfaces of the bumper 112b are connected by being rounded.

The body 110 may include a bumper auxiliary portion 112c disposed to surround the outer surface of the bumper 112b. The bumper auxiliary portion 112c surrounds a lower part of the front surface and the left and right sides of the bumper 112b. The bumper auxiliary portion 112c may cover the lower half of the front surface and the left and right sides of the bumper 112b.

The bumper auxiliary portion 112c has a front end surface disposed forward of a front end surface of the bumper 112b. The bumper auxiliary portion 112c forms a surface protruding from a surface of the bumper 112b. The bumper auxiliary portion 112c may be formed of a material that is suitable for absorbing shock, such as rubber. The bumper auxiliary portion 112c may be formed of a flexible material.

The mobile robot 100 includes a driving wheel module 120 that allows the body 110 to move relative to the ground (a travel surface). The driving wheel module 120 includes a first wheel 120a and a second wheel 120b provided on left and right sides, respectively, to be independently rotatable. The mobile robot 100 includes a driving motor module 130 providing rotational force to the driving wheel module 120. The driving motor module 130 includes a first motor 130a providing rotational force to the first wheel 120a and a second motor 130b providing rotational force to the second wheel 120b. The first motor 130a is disposed to the left of the second motor 130b. The mobile robot 100 includes the blade 140 rotatably provided for mowing grass. The mobile robot 100 includes a blade motor providing rotational force to the blade 140. The mobile robot 100 includes a battery Bt that supplies power to the driving motor module 130. The battery Bt may supply power to the blade motor.

The mobile robot 100 includes a sensor disposed in the inner space of the body 110. The sensor has a gyro detecting function and a magnetic field detecting function. The sensor may further include an acceleration detecting function.

The mobile robot 100 includes an obstacle detector 161 that detects an obstacle on the front. A plurality of the obstacle detectors 161a, 161b, and 161c may be provided. The obstacle detector 161 is disposed on the front surface of the body 110. The obstacle detector 161 is disposed upward from the frame 111.

The mobile robot 100 may include a rain detector (not shown) that detects rain. The rain detector may be disposed in the case 112. The lane detector may be disposed upward from the frame 111.

The mobile robot 100 includes a remote signal receiver 101 that receives an external remote signal. In response to a remote signal being transmitted from an external remote controller, the remote signal receiver 101 may receive the remote signal. For example, the remote signal may be an infrared signal. The signal received by the remote signal receiver 101 may be processed by a controller 190.

A plurality of the remote signal receivers 101 may be provided. The plurality of remote signal receivers 101 include a first remote signal receiver 101a disposed on the front side of the body 110 and a second remote signal receiver 101b disposed on the rear side of the body 110. The first remote signal receiver 101a receives a remote signal transmitted from the front. The second remote signal receiver 101b receives a remote signal transmitted from the rear.

The mobile robot 100 includes an auxiliary wheel 162 disposed at the front of the first wheel 120a and the second wheel 120b. The auxiliary wheel 162 may be disposed at the front of the blade 140. The auxiliary wheel 162 is a wheel that does not receive a driving force of the motor and serves to assist the body 110 with respect to the ground. A caster supporting the rotation axis of the auxiliary wheel 162 is coupled to the frame 111 so as to be rotatable about a vertical axis. A first auxiliary wheel 162a disposed on the left side and a second auxiliary wheel 162b disposed on the right side may be provided.

The mobile robot 100 includes a global positioning system (GPS) board provided to detect a GPS signal. The GPS board may be a printed circuit board (PCB).

The mobile robot 100 includes a docking insertion portion 169 configured to be connected to a charging station 50 based on being docked onto the charging station 50. The docking insertion portion 169 is recessed such that a docking connection portion (not shown) of the charging station 50 is inserted thereinto. The docking insertion portion 169 is disposed on the front center of the body 110. By the connection of the docking insertion portion 169 and the docking connection portion, the mobile robot 100 may be guided to an accurate position for charging.

The mobile robot 100 may include a charging corresponding terminal 102 disposed at a position provided to be in contact with a charging terminal (not shown) in a state in which the docking insertion portion 169 is inserted into the docking connection portion. The charging corresponding terminal 102 may include a pair of charging corresponding terminals 102a and 102b disposed at positions corresponding to a pair of charging terminals. The pair of charging corresponding terminals 102a and 102b may be disposed on the left and right sides with the docking insertion portion 169 interposed therebetween. In addition, the mobile robot 100 may be provided with a terminal contact sensor 173 and upon contact with the charging terminal of the charging station 50, transmit a contact signal to the controller 190. Accordingly, the controller 190 may identify that the mobile robot 100 is docked onto the charging station 50.

The mobile robot 100 may be provided with a terminal cover (not shown) covering the docking insertion portion 169 and the pair of charging terminals to be opened and closed. When the mobile robot 100 travels, the terminal cover may cover the docking insertion portion 169 and the pair of charging terminals. When the mobile robot 100 is connected to the charging station 50, the terminal cover may be opened such that the docking insertion portion 169 and the pair of charging terminals may be exposed.

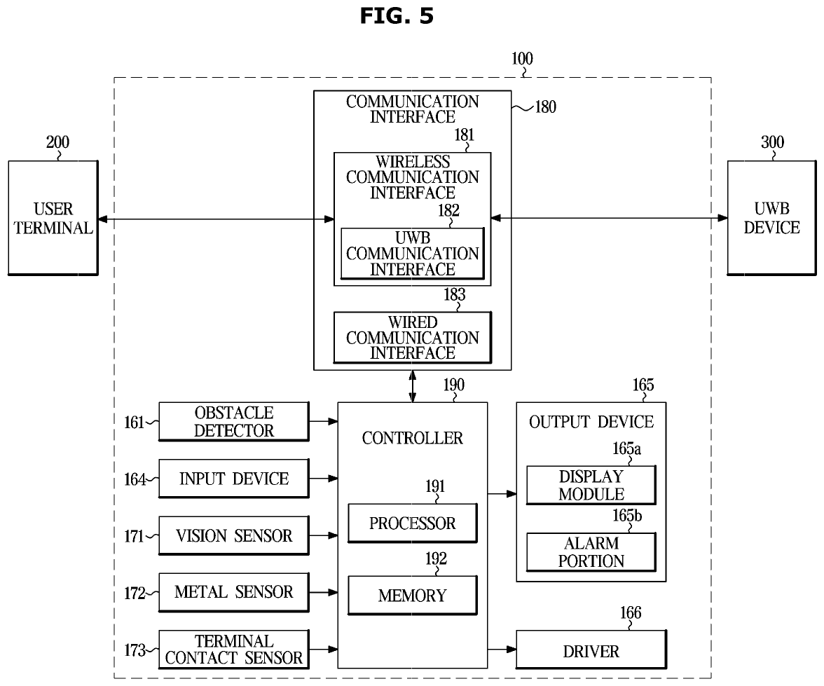

FIG. 5 is a control block diagram illustrating a mobile robot according to an embodiment.

Referring to FIG. 5, the mobile robot 100 according to an embodiment may include an obstacle detector 161, an input device 164, an output device 165, a driver 166, a vision sensor 171, a metal sensor 172, a terminal contact sensor 173, a communication interface 180, and a controller 190.

The mobile robot 100 may include the obstacle detector 161 that detects a forward obstacle, and may include a plurality of the obstacle detectors 161a, 161b, and 161c. The obstacle detector 161 may be disposed on the front side of the body 110, and the obstacle detector 161 may be disposed upward from the frame 111. The obstacle detector 161 may detect an obstacle on a travelling path and obtain information for correcting the path of the mobile robot 100.

The input device 164 may receive various user instructions. The input device 164 may include a button, a dial, a touch type display, and the like. The input device 164 may include a microphone (not shown) for speech recognition. In the embodiment, a number of buttons are disposed on the upper side of the case 112.

The output device 165 may output various types of information related to the operation of the mobile robot 100 to the user. The output device 165 may include a display module 165a that outputs visual information. The output device 165 may include an alarm portion 165b that outputs auditory information. In addition, according to embodiments, the communication interface 180 may be included in the output device 165.

As will be described below, the output device 165 may transmit a notification regarding completion of docking and start of charging of the mobile robot 100.

In one embodiment, the display module 165a outputs an image in an upward direction. The display module 165a is disposed on the upper side of the case 112. For example, the display module 165a may include a thin film transistor liquid crystal display (LCD) panel. In addition, the display module 165a may be implemented using various display panels, such as a plasma display panel or an organic light emitting diode display panel.

The driver 166 may generate a driving signal for transmitting driving force to the first wheel 120a and the second wheel 120b of the mobile robot 100. That is, the driver 166 may, upon receiving a driving control signal from the controller 190, generate a driving force to the mobile robot 100, and change the angles of the first wheel 120a and the second wheel 120b to change the movement path of the robot 100.

The vision sensor 171 may obtain image information on a travelling path of the mobile robot 100.

The vision sensor 171 may photograph the surroundings of the mobile robot 100 on the traveling path of the mobile robot 100 to obtain surrounding image information. In addition, the vision sensor 171 may obtain position information of a path or area in which the mobile robot 100 is traveling.

The vision sensor 171 may include an RGB camera capable of detecting the shape or color of an object according to an embodiment. In addition, the vision sensor 171 may be an RGB-D camera capable of detecting the shape or color and distance of an object according to an embodiment.

In addition, the vision sensor 171 may distinguish and recognize a work area (an area in which grass is positioned) from a non-work area on the travelling path of the mobile robot 100, and obtain position information of a boundary between the work area and the non-work area.

The metal sensor 172 may be located on a lower portion of the body of the mobile robot 100 and may detect a metal guide 51 provided on the ground. The metal sensor 172 may use electromagnetic induction and eddy current to detect a metal material.

Since an eddy current is generated in a metal when a magnetic field is generated by a coil through which an alternating current flows, the metal sensor 172 may detect the metal using a magnetic field generated by the eddy current. However, the metal sensor 172 of the mobile robot 100 according to an embodiment is not limited thereto, and may include any method capable of detecting a metal material at a certain distance.

The terminal contact sensor 173 is a sensor that generates a signal regarding whether the mobile robot 100 is docked onto the charging station 50, and may include a pressure-sensitive sensor (a switch-type sensor) or a capacitive sensor. However, the terminal contact sensor 173 of the mobile robot 100 according to an embodiment of the disclosure is not limited thereto, and may include any method capable of identifying docking of the mobile robot 100 with the charging station 50.

The terminal contact sensor 173 may transmit a signal about whether the mobile robot 100 is docked onto the charging station 50 to the controller 190, and the controller 190 may allow a docking completion and charging start message to be displayed on the output device 165 or to be transmitted to the user terminal 200 depending whether the mobile robot 100 is docked.

The mobile robot 100 may include the communication interface 180 for communicating with a user terminal 200, an ultra-wideband (UWB) device 300, a server, and a router. The communication interface may vary according to a communication method of another device or server to be communicated with.

The communication interface 180 may exchange data with the user terminal 200 and/or the UWB device 300 and/or external home appliances.

The communication interface 180 may include a wireless communication interface 181 that wirelessly exchanges data with external devices, a UWB communication interface 182 that receives a UWB signal from a UWB device, and a wired communication interface 183 that exchanges data by wire.

The wireless communication interface 181 may wirelessly communicate with a base station or access point (AP), and may access a wired communication network through the base station or access point. The wireless communication interface 181 may communicate with external devices connected to a wired communication network via a base station or access point. For example, the wireless communication interface 181 may wirelessly communicate with an access point using Wi-Fi™ (IEEE 802.11 technology standard), or communicate with a base station using CDMA, WCDMA, GSM, Long Term Evolution (LET), WiBro, and the like. The wireless communication interface 181 may receive data from external devices via a base station or an access point.

In addition, the wireless communication interface 181 may directly communicate with external devices. For example, the wireless communication interface 181 wirelessly receives data from external devices using Wi-Fi, Bluetooth™ (IEEE 802.15.1 technology standard), ZigBee™ (IEEE 802.15.4 technology standard), and the like.

The UWB communication interface 182 may wirelessly communicate with the UWB device 300. In this case, the UWB device 300 may include at least one beacon. The beacon included in the UWB device 300 may be provided at an arbitrary position in a space in which the mobile robot 100 moves. When the UWB communication interface 182 receives signals from three or more beacons, the controller may obtain the current position of the mobile robot 100 through position information of the beacons previously stored in the memory 192.

In addition, the mobile robot 100 may obtain the current position of the mobile robot 100 using the principle of GPS through the position information of the beacons received by the UWB communication interface from three or more beacons.

The wired communication interface 183 may access a wired communication network and communicate with external devices through the wired communication network. For example, the wired communication interface 183 may access a wired communication network through Ethernet (IEEE 802.3 technology standard) and receive data from external devices through the wired communication network.

The controller 190 may process user input and/or metal guide detection data and/or communication data, and may control components for docking the mobile robot 100 onto the charging station 50 based on the data processing.

The controller 190 includes the memory 192 for storing/memorizing programs and/or data, and the processor 191 for processing user input and/or metal guide detection data and/or communication data according to the programs and/or the data memorized in the memory 192.

The controller 190 may further include software such as programs and/or data stored in the memory 192 and processed by the processor 191 as well as hardware such as the memory 192 and the processor 191.

The memory 192 may store/memorize programs and/or data. The program includes a plurality of instructions combined to perform a specific function, and the data may be handled and/or processed by the plurality of instructions included in the program. In addition, the program and/or data may include a system program and/or system data directly related to the operation of the mobile robot 100, and an application program and/or application data providing convenience and fun to the user.

The memory 192 may include a non-volatile memory that stores programs and/or data for controlling components included in the mobile robot 100 and a volatile memory that stores temporary data generated while controlling components included in the mobile robot 100.

The non-volatile memory may, for example, store programs and/or data electrically or magnetically or optically. The non-volatile memory may include, for example, a read only memory (ROM) and a flash memory for long-term storage of data. In addition, the non-volatile memory may include a solid state driver (SSD), a hard disk drive (HDD), an optical disk drive (ODD), or the like.

The volatile memory may, for example, load programs and/or data from the non-volatile memory and electrically store programs and/or data. The volatile memory may include, for example, a static random access memory (S-RAM) and a dynamic random access memory (D-RAM) for temporarily storing data.

The memory 192 may store/memorize programs and data such as an operating system (OS), middleware, and applications, and provide programs and data to the processor 191 in response to a request of the processor 191.

The processor 191 may process inputs of a user and/or detecting data of the metal sensor 172 and/or communication data of the communication interface 180 according to programs and/or data memorized/stored in the memory 192. In addition, the processor 191 may generate a control signal for controlling the operation of the mobile robot 100 based on data processing.

For example, the processor 191 may obtain position information of the mobile robot by communicating with the beacon, obtain a distance between the mobile robot and the charging station based on the position information of the mobile robot and indoor map information, and based on the distance being less than or equal to a first reference distance, operate for the metal sensor to detect the metal guide.

In addition, the processor 191 may control the driver 166 such that the mobile robot 100 travels along the metal guide 51 and docks onto the charging station 50.

In addition, the processor 191 may, based on detecting absence of the metal guide 51 for a second reference distance or more while traveling along the metal guide 51, stop detecting the metal guide 51, and change the position of the mobile robot 100 and rediscover the metal guide 51.

In addition, the processor 191 may, based on increase in the distance between the mobile robot 100 and the charging station 50 while traveling along the metal guide 51, stop detecting the metal guide 51, and change the position of the mobile robot 100 and rediscover the metal guide 51.

In addition, the processor 191 may, based on the metal guide 51 and the metal sensor 172 being provided in plural, determine a metal sensor 172, among the plurality of metal sensors 172, which has detected the metal guide 51.

In addition, the processor 191 may control, based on the position of the determined metal sensor 172, a movement angle of the mobile robot 100 for docking.

In addition, the processor 191 may, based on completion of the docking, display a docking completion and charging start message on the output device 165.

In addition, the processor 191 may, based on completion of the docking, control the communication interface 180 to transmit a docking completion and charging start message to the user terminal 200.

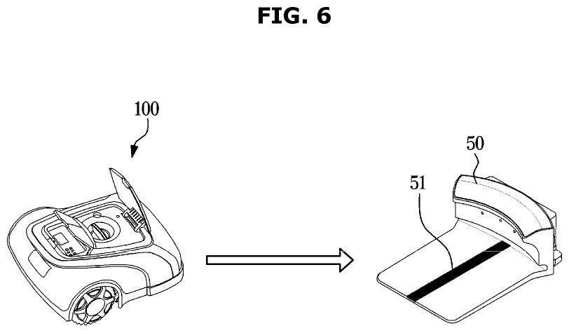

FIG. 6 is a schematic view illustrating a mobile robot and a charging station for the mobile robot according to an embodiment.

Referring to FIG. 6, the mobile robot 100 may have a battery charged at the charging station 50. The charging station 50 is a charging device for charging a battery of the mobile robot 100, and may be termed as a docking station or a base station.

The charging station 50 may be fixedly installed at a position in the use environment of the mobile robot 100 and may be connected to an external power source. The charging station 50 may basically charge the battery of the mobile robot 100 when the mobile robot 100 is docked thereon, and may perform various other maintenance operations of the mobile robot 100.

The charging station 50 may be further provided with various components. For example, the charging station 50 may further include a power control circuit installed inside the charging station 50 and configured to convert external power (AC) such that the mobile robot 100 is supplied with battery charging power (DC) through a connector for charging.

The mobile robot 100 may be controlled to dock onto the charging station 50 or avoid the charging station 50 according to the position relative to the charging station 50.

The charging station 50 may have a lower surface that may be in contact with the driving wheel module 120 and the auxiliary wheel 160 of the mobile robot 100, and the lower surface may include at least one metal guide 51.

Accordingly, the mobile robot 100 may operate the metal sensor 172 to detect the metal guide 51 provided on the lower surface of the charging station 50.

The mobile robot 100 may, upon entering an area within a preset reference distance from the charging station 50, operate the metal sensor 172 to detect the metal guide 51. That is, the mobile robot 100 may, upon being located outside the preset reference distance from the charging station 50, approach the charging station 50 through UWB communication and, upon being located within the preset reference distance, detect the metal on the lower surface using the metal sensor 172.

Accordingly, the mobile robot 100 may correct the posture of the mobile robot 100 in a direction in which the metal guide 51 is detected, and travel along the metal guide 51 and complete docking.

As the mobile robot 100 detects the metal guide 51 and performs docking along the metal guide 51, degradation of the docking performance due to contamination around the charging station 50 may be prevented.

That is, the mobile robot 100 according to an embodiment may accurately determine a docking path by the nature of the metal sensor 172 that uses a magnetic field, even when the vicinity of the charging station 50 is contaminated with contaminants.

For example, the mobile robot 100 may, even with a difficulty in identifying the docking path using a vision sensor because the charging station 50 is covered with cut grass, operate the metal sensor 172 to detect the metal guide (located below the cut grass) 51, and thus performance degradation due to the contamination around the charging station 50 may be prevented.

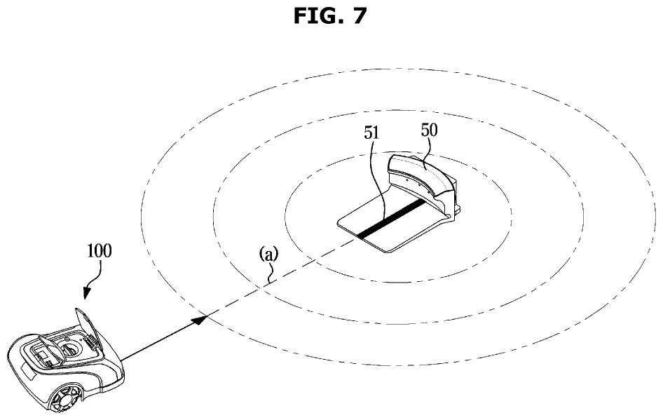

The mobile robot 100 according to an embodiment operates the metal sensor 172 upon being located within the preset reference distance, and details thereof will be described below in FIG. 7.

FIG. 7 is a view illustrating a case in which a mobile robot moves to an area within a reference distance according to an embodiment.

The mobile robot 100 according to an embodiment may perform communication with the charging station 50 through the UWB communication interface 182 to obtain a distance and an angle between the mobile robot 100 and the charging station 50 communication interface 182. Here, the angle between the mobile robot 100 and the charging station 50 may represent an angle between a first axis parallel to the traveling direction of the mobile robot 100 and a second axis passing through the mobile robot 100 and the charging station 50.

For example, the controller 190 may transmit a first UWB signal to the charging station 50 through the UWB communication interface 182. In addition, the processor 191 may receive a second UWB signal from the charging station 50 in response to the first UWB signal. In this case, the processor 191 may calculate the distance between the mobile robot 100 and the charging station 50 based on the time at which the first UWB signal is transmitted and the time at which the second UWB signal is received.

In addition, the controller 190 may obtain the angle between the mobile robot 100 and the charging station 50 based on a difference in phases of second UWB signals received by a plurality of antennas included in the UWB communication interface 182. Accordingly, the controller 190 may obtain a relative position of the mobile robot 100 and the charging station 50.

In addition, the controller 190 may obtain a current position of the mobile robot 100 from the UWB device 300 including the beacon, and based on indoor map information stored in the memory 192, calculate a positional difference of the current position of the mobile robot 100 and the position of the charging station 50 displayed on the indoor map information to obtain a relative position of the mobile robot 100 and the charging station 50.

In this case, the indoor map information may be stored in the memory 192 by Simultaneous Localization And Mapping (SLAM). SLAM may generate a map of a surrounding environment of the mobile robot 100 while estimating the position of the mobile robot 100 in the generated map. Through the SLAM algorithm, the mobile robot 100 may generate a map of an unknown environment and store the map in the indoor map information.

The mobile robot 100 according to an embodiment is illustrated as obtaining the distance from the mobile robot 100 to the charging station 50 based on the current position of the mobile robot 100 and the indoor map information, but the disclosure is not limited thereto, and may include any configuration as long as it can obtain the distance from the mobile robot 100 to the charging station 50 without limitation.

The controller 190 may obtain the distance from the mobile robot 100 to the charging station 50 and identify whether the distance between the mobile robot 100 and the charging station 50 is less than or equal to a preset reference distance a.

The memory 192 may store the preset reference distance a as 1 m, and the controller 190 may identify whether the distance from the current position of the mobile robot 100 to the charging station 50 is 1 m or less. In addition, the memory 192 may store the preset reference distance a as 2 m, and the controller 190 may identify whether the distance from the current position of the mobile robot 100 to the charging station 50 is 2 m or less. Alternatively, the preset reference distance a may be directly set by the designer of the mobile robot 100 or the user.

The controller 190 may, upon identifying that the distance between the mobile robot 100 and the charging station 50 being less than or equal to the preset reference distance a, operate the metal sensor 172 to detect the metal guide 51. Since the controller 190 operates the metal sensor 172 only upon being located within the preset reference distance a, the metal guide 51 only needs to be provided in an area within the reference distance a, so that the ease of installation may be increased, and the installation cost of the metal guide 51 may be reduced.

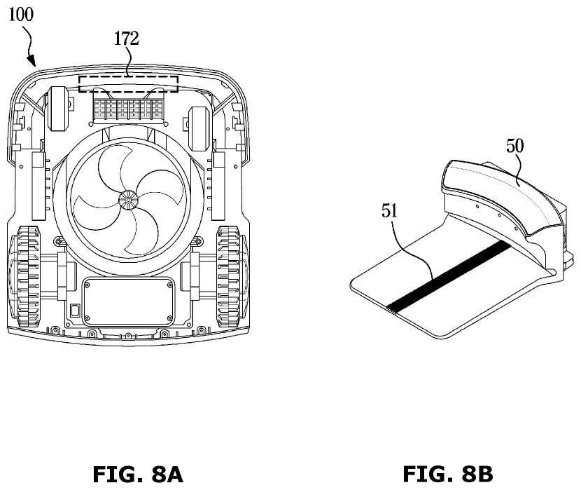

FIG. 8A is a view illustrating a metal guide 51 and a metal sensor 172 of a mobile robot 100 according to an embodiment, and FIG. 8B is a view illustrating a metal guide 51 and a metal sensor 172 of a mobile robot 100 according to an embodiment.

Referring to FIG. 8A, the mobile robot 100 according to an embodiment may include a single metal sensor 172, and referring to FIG. 8B, the charging station 50 may include a single metal guide 51.

The mobile robot 100 may, in response to input of a charging return mode, approach the charging station 50 and enter an area within a preset reference distance using the SLAM algorithm, and then the controller 190 may operate the metal sensor 172. As shown in FIG. 8A, the metal sensor 172 may be disposed on the front side of the mobile robot 100, but the position is not limited thereto.

The controller 190 may, after operating the metal sensor 172, travel in a direction of approaching the charging station 50 to detect the metal guide 51. Accordingly, the metal sensor 172 may detect metal material, and upon metal material being detected, transmit a signal indicating that the metal material has been detected to the controller 190.

Thereafter, while the metal sensor 172 may keep detecting metal, the controller 190 may, upon the detected metal connecting in a specific direction by a preset thickness, identify that the detected metal is the metal guide 51.

The controller 190 may change the direction of the mobile robot 100 in the direction in which the metal guide 51 extends, and control the driver 166 to travel in the direction in which the metal guide 51 extends.

Since the metal guide 51 is provided at a position in which the mobile robot 100 is accurately docked onto the charging station 50, the mobile robot 100 may perform precise docking onto the charging station 50 by traveling in the extension direction of the metal guide 51.

However, the controller 190 may, upon the metal sensor 172 not being identified even by receiving the signal indicating that the metal material has been detected from the metal sensor 172, keep traveling to discover the metal guide 51.

According to an embodiment, the controller 190 may, based on detecting absence of the metal guide 51 for a preset reference distance or more while travelling along the metal guide 51, identify that other metal material than the metal guide 51 has been detected, and stop detecting and change the position of the mobile robot 100. Thereafter, the controller 190 may perform rediscovery to detect the metal guide 51.

That is, since the metal guide 51 provided in the charging station 50 has a certain thickness and extends in a specific direction, the controller 190 may, in response to metal material being disconnected, identify that other metal material than the metal guide 51 has been mistakenly detected as the metal guide 51.

In addition, the controller 190 may, based on increase in the distance between the mobile robot 100 and the charging station 50 while traveling along the metal guide 51, stop detecting, and change the position of the mobile robot 100. Thereafter, the controller 190 may perform rediscovery to detect the metal guide 51.

That is, the mobile robot 100 travels along the metal guide 51 for docking, and increasing distance from the charging station 50 may be taken to mean that the mobile robot 100 follows the metal guide 51 in a direction opposite to the docking direction. Accordingly, the controller 190 may, in order to travel in the correct direction for docking, stop detecting the metal guide 51 and rediscover the metal guide 51 in a new direction.

As described above, the mobile robot 100 may operate the metal sensor 172 to reduce the time for docking onto the charging station 50, and perform accurate docking.

Hereinafter, an embodiment in which the metal guide 51 and the metal sensor 172 are provided in plural, and an embodiment in which the metal guide 51 extends to the outside of the charging station 50 will be described.

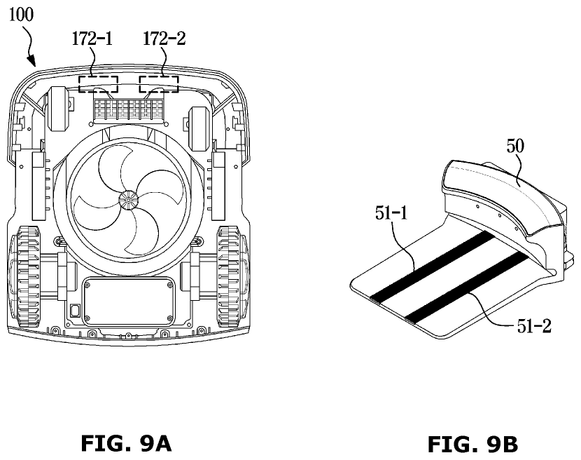

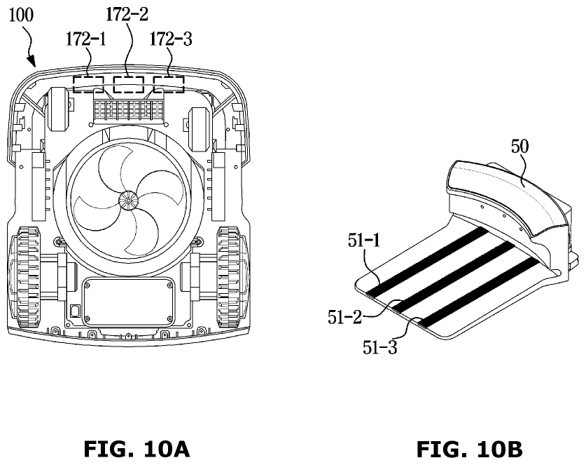

FIG. 9A is view illustrating a case in which a plurality of metal sensors of a mobile robot are provided according to an embodiment, FIG. 9B is view illustrating a case in which a plurality of metal guides of a mobile robot are provided according to an embodiment, FIG. 10A is view illustrating a case in which a plurality of metal sensors of a mobile robot are provided according to an embodiment, and FIG. 10B is view illustrating a case in which a plurality of metal guides of a mobile robot are provided according to an embodiment.

Referring to FIG. 9A, the mobile robot 100 according to an embodiment may include two metal sensors 172, and referring to FIG. 9B, the charging station 50 may include two metal guides 51.

Although the two metal guides 51 are illustrated as being in parallel in FIG. 9B, the metal guides 51 may be provided at a predetermined angle therebetween. In addition, although the two metal sensors 172 are illustrated as being provided on the front side of the mobile robot 100, there is no limitation on the position of each of the metal sensors 172.

The controller 190 may, upon identifying that the mobile robot 100 approaches the charging station 50 and enter an area within a reference distance from the charging station 50, operate a first metal sensor 172-1 and a second metal sensor 172-2. Accordingly, each of the first metal sensor 172-1 and the second metal sensor 172-2 may detect the metal guide 51, and a case in which both of the two metal sensors 172 detect the metal guides 51 is identified as a normal travelling state for docking.

On the other hand, the controller 190 may, based on a detection signal being received by only one metal sensor 172 between the first metal sensor 172-1 and the second metal sensor 172-2, change the movement angle of the mobile robot 100 for accurate docking.

For example, the controller 190 may, based on the metal guide 51 being detected only by the first metal sensor 172-1, identify that the first metal sensor 172-1 has detected the second metal guide 51-2, and may change the movement angle of the mobile robot 100 to the left by a preset movement value.

In addition, the controller 190 may, based on the metal guide 51 being detected only by the second metal sensor 172-2, identify that the second metal sensor 172-2 has detected the first metal guide 51-1, and may change the movement angle of the mobile robot 100 to the right by a preset movement value. Accordingly, the mobile robot 100 may perform more accurate docking compared to when only one metal guide 51 is provided.

In addition, similarly to the description with reference to FIGS. 8A and 8B, the controller 190 may detect the metal guides 51, and based on detecting absence of at least one of the metal guides 51 for a preset reference distance or more while travelling along the metal guides 51, identify that other metal material than the metal guide 51 has been detected, and stop detecting. Thereafter, the controller 190 may change the position of the mobile robot 100, and may perform rediscover to detect the metal guides 51.

In addition, the controller 190 may, based on increase in the distance between the mobile robot 100 and the charging station 50 while traveling along the metal guides 51, stop detecting, and change the position of the mobile robot 100. Thereafter, the controller 190 may perform rediscovery to detect the metal guides 51.

Referring to FIG. 10A, the mobile robot 100 according to an embodiment may include three metal sensors 172, and referring to FIG. 10B, the charging station 50 may include three metal guides 51.

Although the three metal guides 51 are shown in parallel in FIG. 10B, the metal guides 51 may be provided at a predetermined angle therebetween. In addition, although the three metal sensors 172 are illustrated as being provided on the front side of the mobile robot 100, there is no limitation on the position of each of the metal sensors 172.

The controller 190 may, upon identifying that the mobile robot 100 approaches the charging station 50 and enter an area within a reference distance from the charging station 50, operate a first metal sensor 172-1, a second metal sensor 172-2, and a third metal sensor 172-3. Accordingly, each of the first metal sensor 172-1, the second metal sensor 172-2, and the third metal sensor 172-3 may detect the metal guide 51, and a case in which all of the three metal sensors 172 detect the metal guides 51 is identified as a normal travelling state for docking.

On the other hand, the controller 190 may, based on a detection signal being received by only one metal sensor 172 among the first metal sensor 172-1, the second metal sensor 172-2, and the metal sensor 172-3 being receiving a detection signal, change the movement angle of the mobile robot 100 for accurate docking.

For example, the controller 190 may, based on the metal guide 51 being detected only by the first metal sensor 172-1, identify that the first metal sensor 172-1 has detected the third metal guide 51-3, and may change the movement angle of the mobile robot 100 to the left by a preset movement value.

In addition, the controller 190 may, based on the metal guide 51 being detected only by the third metal sensor 172-3, identify that the third metal sensor 172-3 has detected the first metal guide 51-1, and may change the movement angle of the mobile robot 100 to the right by a preset movement value.

In addition, the controller 190 may, based on the metal guides 51 being detected only by the first metal sensor 172-1 and the second metal sensor 172-2, identify that the first metal sensor 172-1 has detected the second metal guide 51-2 and the second metal sensor 172-2 has detected the third metal guide 51-3, and may change the movement angle of the mobile robot 100 to the left by a preset movement value.

In addition, the controller 190 may, based on the metal guides 51 being detected only by the second metal sensor 172-2 and the third metal sensor 172-3, identify that the second metal sensor 172-2 has detected the first metal guide 51-1 and the third metal sensor 172-3 has detected the second metal guide 51-2, and may change the movement angle of the mobile robot 100 to the right by a preset movement value.

As described above, the mobile robot 100 according to the embodiment includes the plurality of metal sensors 172 and the charging station 50 includes the plurality of metal guides 51, and thus more accurate docking may be achieved.

In addition, similarly to the description with reference to FIGS. 9A and 9B, the controller 190 may detect the three metal guides 51, and based on detecting absence of at least one of the metal guides 51 for a preset reference distance or more while travelling along the metal guides 51, identify that other metal material than the metal guides 51 has been detected, and stop detecting. Thereafter, the controller 190 may change the position of the mobile robot 100, and may perform rediscovery to detect the metal guides 51.

In addition, the controller 190 may, based on increase in the distance between the mobile robot 100 and the charging station 50 while traveling along the three metal guides 51, stop detecting, and change the position of the mobile robot 100. Thereafter, the controller 190 may perform rediscovery to detect the metal guides 51.

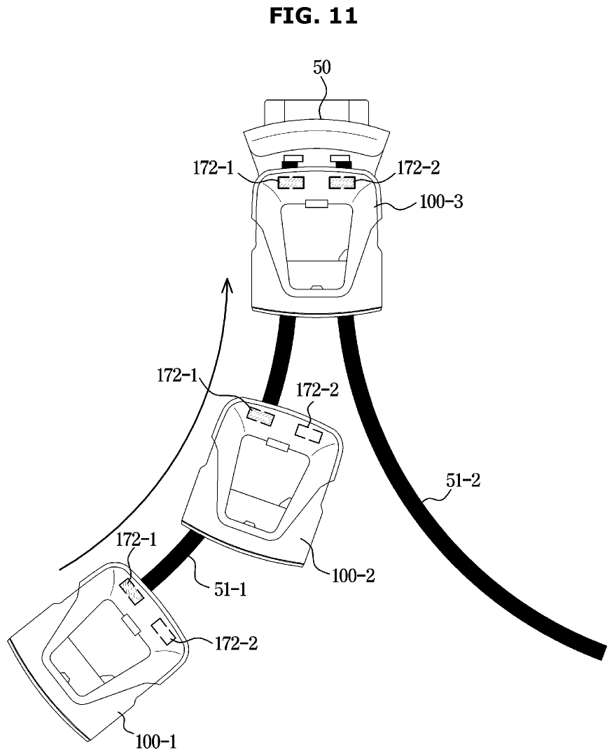

FIG. 11 is a view illustrating a case in which a metal guide 51 is detected only by some metal sensor of a mobile robot 100 according to an embodiment.

Referring to FIG. 11, the metal guide 51 according to an embodiment may be protruded outside of the charging station 50 and curved in different directions.

The controller 190 may, upon the mobile robot 100 approaching the charging station 50 and entering an area within a reference distance from the charging station 50, detect one of the first metal guide 51-1 and the second metal guide 51-2. The controller 190 may obtain information about the metal sensor 172 that has detected the one of the first metal guide 51-1 and the second metal guide 51-2, and change the movement angle of the mobile robot 100 based on the obtained information of the metal sensor 172.

For example, as shown in FIG. 11, when only the first metal sensor 172-1 has detected the metal guide 51, the controller 190 may identify whether the first metal sensor 172-1 has detected the first metal guide 51-1 or has detected the second metal guide 51-2 based on a change in direction of the metal guide 51.

That is, since the metal guide 51 detected in FIG. 11 is formed to be curved to the left, the controller 190 may determine the detected metal guide 51 as the first metal guide 51-1. Conversely, when the detected metal guide 51 is formed to be curved to the right, the detected metal guide 51 may be determined as the second metal guide 51-2.

Accordingly, the controller 190 may, based on the detected metal guide 51 being identified as the first metal guide 51-1, rotate and move the mobile robot 100 to the left by a preset movement value (100-1->100-2->100-3). Conversely, the controller 190 may, based on the detected metal guide 51 being identified as the second metal guide 51-2, rotate and move the mobile robot 100 to the right by a preset movement value.

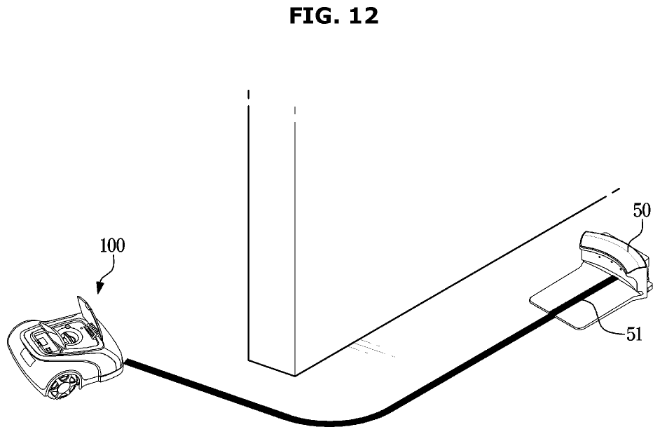

FIG. 12 is a view illustrating a case in which a metal guide protrudes outward from a charging station to allow obstacle avoidance according to an embodiment.

Referring to FIG. 12, the metal guide 51 may be formed to protrude outward from the charging station 50 and extend for obstacle avoidance. In FIG. 12, the metal guide 51 is illustrated as one unit, but it is not limited thereto, and the metal guide 51 may be provided in plural.

In an environment in which the charging station 50 is installed adjacent to an obstacle, it may be difficult for the mobile robot 100 to approach the charging station 50 at the shortest distance. That is, there may be a case in which the mobile robot 100 may approach the charging station 50 through an unnecessary path in the process of avoiding an obstacle.

However, the metal guide 51 according to the embodiment may be protruded from the lower end of the station and installed as the shortest path for obstacle avoidance. Accordingly, the mobile robot 100 may approach the charging station 50 and enter an area within a preset reference distance from the charging station 50 and then detect the metal guide 51, and dock onto the charging station 50 along the metal guide 51 while avoiding an obstacle with the shortest path.

That is, since the mobile robot 100 docks along the metal guide 51, the metal guide 51 may be extended for precise guide to the charging station 50 when the charging station 50 is installed in a complex environment with many obstacles.

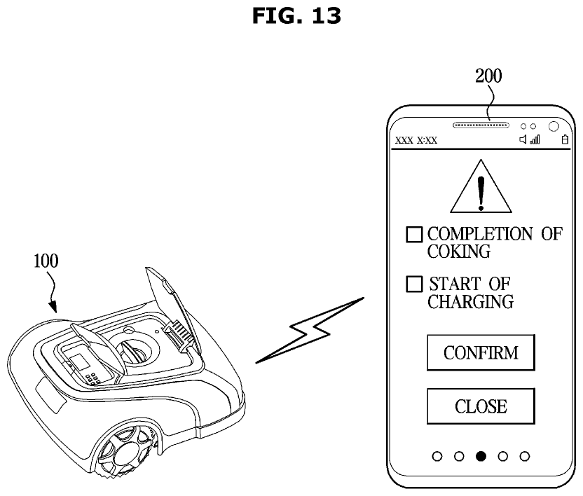

FIG. 13 is a view illustrating a case in which a mobile robot transmits a message to a user terminal according to an embodiment.

Referring to FIG. 13, the mobile robot 100 may, upon docking along the metal guide 51 being completed, control the communication interface 180 to transmit a docking completion and charging start message to the user terminal 200.

As described above, the controller 190 may, based on a contact signal being received from the terminal contact sensor 173, identify that the mobile robot 100 is docked onto the charging station 50, and display a docking completion and charging start message on the output device 165, and transmit a docking completion and charging start message to the user terminal 200.

Accordingly, since the user may easily check that the docking of the mobile robot 100 along the metal guide 51 is completed, and check the charging state, the user may make a plan for utilization of the mobile robot 100 after docking.

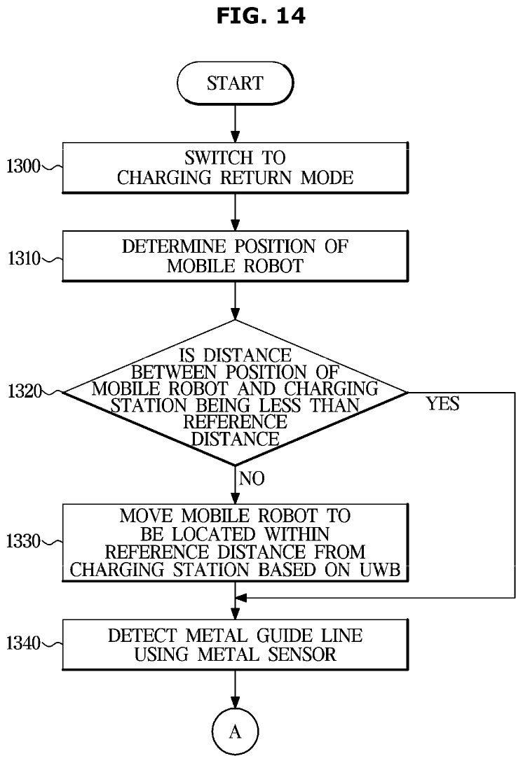

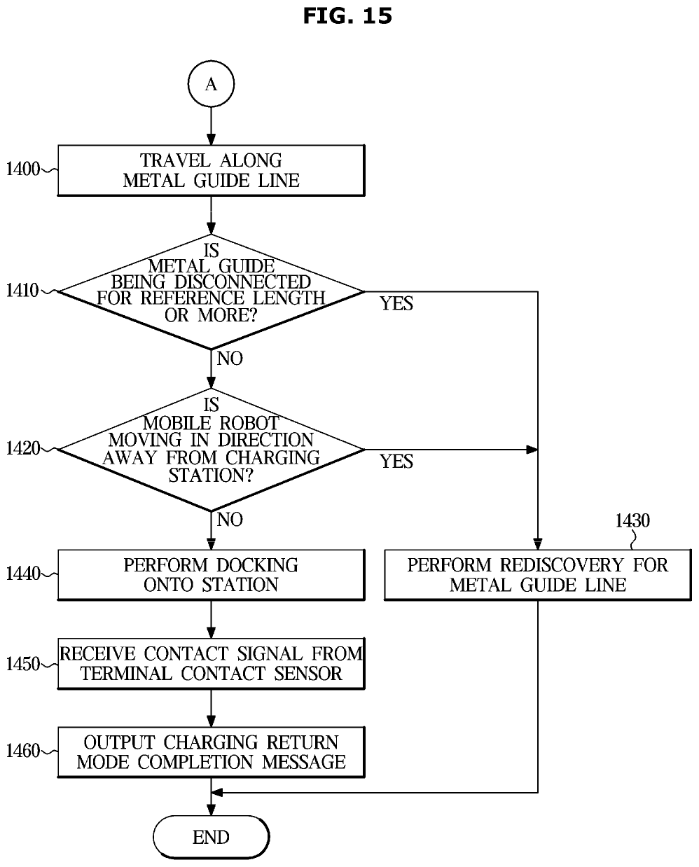

FIG. 14 is a control flowchart of a mobile robot according to an embodiment, and FIG. 15 is a control flowchart of a mobile robot according to an embodiment.

Referring to FIG. 14, the mobile robot 100 may, in response to a command to switch to a charging return mode being received from the user or in response to a battery level decreasing to a preset value or less, switch to a charging return mode (1300).

Thereafter, the controller 190 may determine the current position of the mobile robot 100 as described above (1310). The controller 190 may determine whether the distance between the current position of the mobile robot 100 and the charging station 50 is less than a reference distance based on communication with the charging station 50 or previously stored indoor map information (1320).

The controller 190 may, in response to the distance between the current position of the mobile robot 100 and the charging station 50 not being less than the reference distance, move the mobile robot 100 for the mobile robot 100 to be located within the reference distance from the charging station 50 until the distance between the current position of the mobile robot 100 and the charging station 50 is less than the reference distance (1330).

The controller 190 may, in response to the distance between the current position of the mobile robot 100 and the charging station 50 being less than the reference distance, detect the line of the metal guide 51 using the metal sensor (1340).

Continuously referring to FIG. 15, the controller 190 may allow the mobile robot 100 to travel along the detected metal guide 51 (1400). Then, the controller 190 may identify whether the metal guide 51 is disconnected for a reference length or more, and based on the metal guide 51 being disconnected for the reference length or more (YES in operation 1410), stop detecting the metal guide 51. Then, the controller 190 may change the position of the mobile robot 100 and rediscover to detect the metal guide 51 (1430).

In addition, the controller 190 may identify whether the mobile robot 100 is moving in a direction away from the charging station 50 while travelling along the metal guide 51 (1420). In FIG. 15, an operation of determining whether the metal guide 51 is disconnected by a reference length or more and an operation of determining whether the mobile robot 100 is moving in a direction away from the charging station 50 are sequentially shown, but may simultaneously performed in parallel.

The controller 190 may, upon identifying that the mobile robot 100 is moving in a direction away from the charging station 50 while traveling along the metal guide 51 (YES in operation 1420), stop detecting the metal guide 51. Then, the controller 190 may change the position of the mobile robot 100 and rediscover to detect the metal guide 51 (1430).

The controller 190 may, based on identifying that the mobile robot 100 is moving in a direction toward the charging station 50 while travelling along the metal guide 51 (NO in operation 1420), perform docking onto the station (1440).

Then, the controller 190 may receive a contact signal from the terminal contact sensor 173 (1450), and may allow a charging return mode completion message to be output on the output device 165 or transmitted to the user terminal 200 (1460).

The mobile robot 100 according to the embodiment may be implemented to dock onto the charging station 50 by detecting the metal guide 51 as described above, and thus have robustness to contamination and achieve accurate docking in an environment having a large number of obstacles when compared to the conventional methods.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

In addition, the computer-readable recording medium may be provided in the form of a non-transitory storage medium. Here, when a storage medium is referred to as “non-transitory,” it may be understood that the storage medium is tangible and does not include a signal (electromagnetic waves), but rather that data is semi-permanently or temporarily stored in the storage medium. For example, a ‘non-temporary storage medium’ may include a buffer in which data is temporarily stored.

According to one embodiment, the methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

As is apparent from the above, a mobile robot according to an embodiment and a method of controlling the same can prevent docking performance from being lowered due to contamination around a charging station.

Since a mobile robot according to an embodiment and a method of controlling the same are implemented to allow the mobile robot to estimate the position of a charging station, thereby minimizing required search motion for a charging station.

Since a mobile robot according to an embodiment and a method of controlling the same are implemented to have a metal guide formed to extend outside of a charging station, and thus accurate docking can be performed even in an environment in which complex obstacles are preset near the charging station.

The foregoing detailed descriptions may be merely an example of the disclosure. In addition, the inventive concept is explained by describing the preferred embodiments and will be used through various combinations, modifications and environments. That is the inventive concept may be amended or modified, not being out of the scope, technical idea or knowledge in the art. Further, it is not intended that the scope of this application be limited to these specific embodiments or to their specific features or benefits. Rather, it is intended that the scope of this application be limited solely to the claims which now follow and to their equivalents. Further, the appended claims should be appreciated as a step including even another embodiment.

What is claimed is:

1. A mobile robot comprising:
a communication interface configured to communicate with a beacon;
a metal sensor configured to detect a metal guide connected to a charging station; and
a controller configured to:
control the communication interface to communicate with the beacon to obtain position information of the mobile robot,
obtain a distance between the mobile robot and the charging station based on the obtained position information of the mobile robot and indoor map information, and
based on the obtained distance being less than a first reference distance, operate the metal sensor to detect the metal guide.

2. The mobile robot of claim 1, further comprising:
a driver configured to drive the mobile robot,
wherein the controller is configured to control the driver such that the mobile robot travels along the metal guide and docks onto the charging station.

3. The mobile robot of claim 1, wherein
the controller is configured to, based on detecting absence of the metal guide for a second reference distance after the mobile robot starts traveling along the metal guide:
control the metal sensor to stop detecting the metal guide,
control the mobile robot to change a position, and
after the position of the mobile robot is changed, control the metal sensor to rediscover the metal guide.

4. The mobile robot of claim 1, wherein
the controller is configured to, based on an increase in the distance between the mobile robot and the charging station while traveling along the metal guide:
control the metal sensor to stop detecting the metal guide,
control the mobile robot to change a position of the mobile robot, and
after the position of the mobile robot is changed, control the metal sensor rediscover the metal guide.

5. The mobile robot of claim 1, wherein
the metal guide extends outward from the charging station along a surface on which the mobile robot travels.

6. The mobile robot of claim 1, wherein
the metal guide connected to the charging station includes a plurality of metal guides, and
the metal sensor of the mobile robot includes a plurality of metal sensors corresponding to the plurality of the metal guides.

7. The mobile robot of claim 6, wherein
the controller is configured to determine which metal sensor among the plurality of the metal sensors detects a metal guide among the plurality of the metal guides.

8. The mobile robot of claim 7, wherein
the controller is configured to, based on a position of the determined metal sensor among the plurality of the metal sensors, control a movement angle of the mobile robot for docking onto the charging station.

9. The mobile robot of claim 2, wherein
the controller is configured to, based on completion of the docking onto the charging station, control a docking completion and charging start message to be displayed on an output device.

10. The mobile robot of claim 2, wherein
the controller is configured to, based on completion of the docking onto the charging station, control the communication interface to transmit a docking completion and charging start message to a user terminal.

11. A method of controlling a mobile robot including a communication interface configured to communicate with a beacon, and a metal sensor configured to detect a metal guide connected to a charging station, the method comprising:
communicating with the beacon to obtain position information of the mobile robot;
obtaining a distance between the mobile robot and the charging station based on the obtained position information of the mobile robot and indoor map information; and
based on the obtained distance being less than to a first reference distance, operating the metal sensor to detect the metal guide.

12. The method of claim 11, further comprising:
controlling a driver such that the mobile robot travels along the metal guide and docks onto the charging station.

13. The method of claim 11, further comprising, based on detecting absence of the metal guide for a second reference distance after the mobile robot starts traveling along the metal guide:
stopping detecting the metal guide;
changing a position of the mobile robot; and
after the position of the mobile robot is changed, rediscovering the metal guide.

14. The method of claim 11, further comprising, based on an increase in the distance between the mobile robot and the charging station while traveling along the metal guide:
stopping detecting the metal guide;
changing a position of the mobile robot; and
after the position of the mobile robot is changed, rediscovering the metal guide.

15. The method of claim 11, wherein
the metal guide extends outward from the charging station along a surface on which the mobile robot travels.

16. The method of claim 11, wherein
the metal guide connected to the charging station includes a plurality of metal guides, and
the metal sensor of the mobile robot includes a plurality of metal sensors corresponding to the plurality of the metal guides.

17. The method of claim 16, further comprising:
determining which metal sensor among the plurality of the metal sensors detects a metal guide among the plurality of the metal guides.

18. The method of claim 17, further comprising, based on a position of the determined metal sensor among the plurality of the metal sensors:
controlling a movement angle of the mobile robot for docking onto the charging station.

19. The method of claim 12, further comprising, based on completion of the docking onto the charging station:
displaying a docking completion and charging start message on an output device.

20. The method of claim 12, further comprising, based on completion of the docking onto the charging station:
controlling the communication interface to transmit a docking completion and charging start message to a user terminal.
